(19) United States
(12) Patent Application Publication
(10) Pub. No.: US 2015/0179188 A1
(43) Pub. Date: Jun. 25, 2015

(54) METHOD AND APPARATUS FOR HEARING IMPAIRED ASSISTIVE DEVICE

(71) Applicant: SPEECH MORPHING, INC., Campbell, CA (US)

(72) Inventor: Fathy YASSA, Soquel, CA (US)

(73) Assignee: SPEECH MORPHING, INC., Campbell, CA (US)

(21) Appl. No.: 14/579,620

(22) Filed: Dec. 22, 2014

Related U.S. Application Data
(60) Provisional application No. 61/919,616, filed on Dec. 20, 2013.

(51) Int. Cl. G10L 25/48; G10L 15/00

(52) U.S. Cl. CPC G10L 25/48; G10L 15/00

(57) ABSTRACT

An assistive device for the hearing impaired for hearing human speech through the use of physical stimuli.

### CROSS-REFERENCE TO RELATED APPLICATION

This application claims the benefit of U.S. Provisional Patent Application No. 61/919,616 filed on Dec. 20, 2013, in the U.S. Patent and Trademark Office, the disclosure of which is incorporated herein in its entirety.

### BACKGROUND

1. Field

There are approximately 35 million Americans who suffer from some degree of deafness. Deafness, hearing impairment, or hearing loss is a partial or total inability to hear. Deafness may be caused by many different factors, including, but not limited to, age, noise, illness, chemicals, and physical trauma. Hearing impairments are categorized by their type, their severity, and the age of onset (before or after language is acquired). Furthermore, a hearing impairment may exist in only one ear (unilateral) or in both ears (bilateral).

There are three main types of hearing impairments, conductive hearing impairment, and sensorineural hearing impairment, as well as a combination of the two called mixed hearing loss.

A conductive hearing impairment is present when sound does not reach the inner ear, the cochlea. Dysfunction of the three small bones of the middle ear—malleus, incus, and stapes—may cause conductive hearing loss. The mobility of the ossicles may be impaired for different reasons and disruption of the ossicular chain due to trauma, infection, or anchylosis may also cause hearing loss.

A sensorineural hearing loss is one caused by dysfunction of the inner ear, the cochlea, the nerve that transmits the impulses from the cochlea to the hearing center in the brain or damage in the brain. The most common reason for sensorineural hearing impairment is damage to the hair cells in the cochlea.

Mixed hearing loss is a combination of the two types discussed above.

2. Description of Related Art

Persons with reduced or no hearing can manage hearing loss in any number of ways, including hearing aids, implants, and assistive devices, such as TTD machines.

### SUMMARY

Embodiments of the present application relate to an assistive device for use by, inter alia, hearing impaired persons, to receive audio communications.

Embodiments of the present application also relate to an Automatic Speech Recognizer (“ASR”) and a device designed to convert the ASR's output text into physical stimuli, e.g., percussion, electrical, and visual.

In an embodiment, the device may include one or two gloves outfitted with a series of percussive devices (such as an actuator) configured to tap different points of the user's hands to express words, common phrases, Morse code, or letters.

The human hand, and in particular the finger, has among the densest concentrations of nerves of the human body. As a result, the hand is extremely sensitive; sensitive enough that a person can differentiate a force, whether mechanical, electrical, or vibrational, being applied to one phalange (finger bone) versus its adjacent phalange. Moreover, a person can tell whether a force is being applied to the top, bottom, left, or right potion of the phalange. There are 14 phalanges in the human hand. As each phalange can determine whether a force is being applied to its top, bottom, left, or right side, 56 finger locations, as well as the front and rear side of the palm, are possible.

According to another embodiment, instead of percussive devices, the glove contains electrodes, so that the user gets small jolts of electricity to represent the words, phrases, and letters.

In another embodiment of the invention, the output information (i.e., electricity, taps, vibrations, etc.) is directed to the user's fingers.

In another embodiment, the palm and/or the back of the hand may have a screen to display the output words from the ASR.

The ASR converts the input speech into text. The stimulating device, then converts the output text into taps or pulses that the hearing impaired person can feel and effectively “hear” the conversation.

### BRIEF DESCRIPTION OF THE DRAWINGS

FIG. 1. illustrates an exploded block diagram of a system for allowing a user to “hear” with his or her hands.

FIG. 2 illustrates a flow diagram of a method for hearing with one's hands, according to an embodiment.

### DETAILED DESCRIPTION OF THE EMBODIMENTS

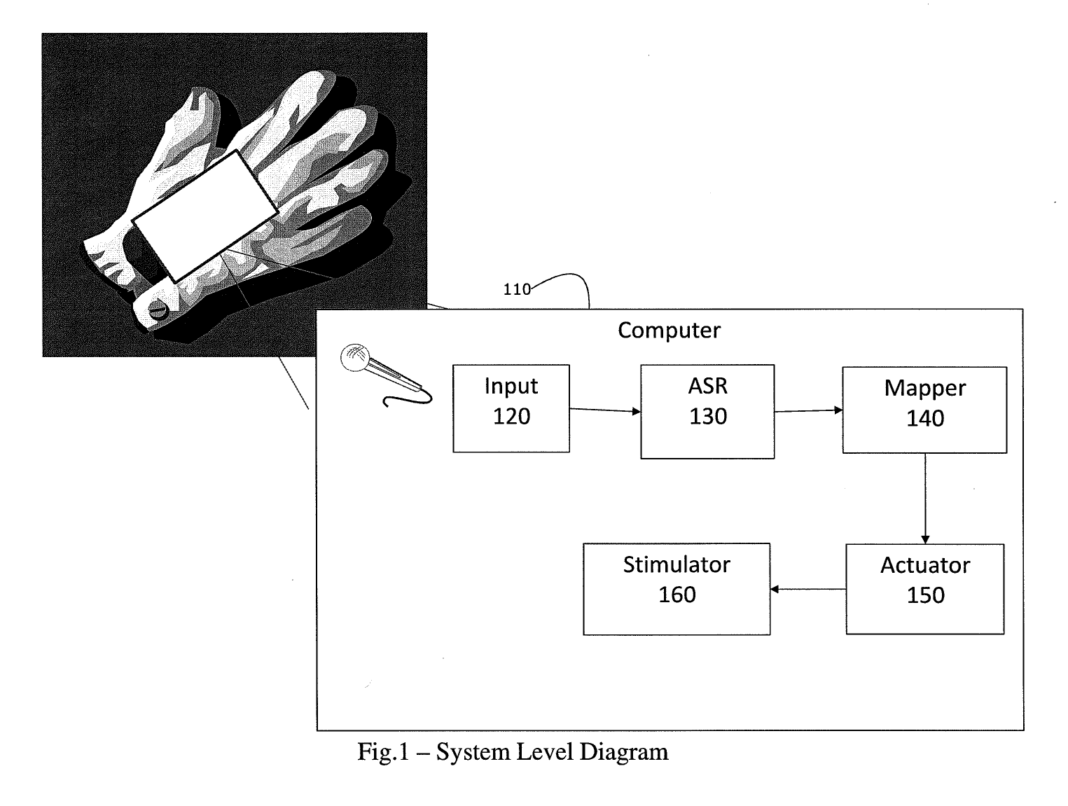

FIG. 1 illustrates a component level diagram for enabling the hearing impaired to hear with their hands, according to an embodiment.

The hearing impaired assistive system in FIG. 1 may be implemented as a computer system 110 comprising several modules, i.e., computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

As illustrated in FIG. 1, the glove is a close-fitting hand covering, e.g., a glove, optimally with a separate compartment for each finger. The glove provides the form factor for computer 110.

Input 120 is a module configured to receive human speech from any audio source, and output the received speech to ASR 130. Input 120 may be a live speaker, a module configured to stream audio, a feed from a videoconference with audio, a module configured to stream audio, and video and/or a module configured to download or store audio or audio/video files.

ASR 130 may be software modules, hardware modules, or a combination of software and hardware modules, whether separate or integrated, working together to perform automatic speech recognition. ASR 130 is configured to receive human speech, segment the speech, decode each speech segment into the best estimate of the phrase by first converting said speech segment into a sequence of vectors which are measured throughout the duration of the speech segment. Then, using a syntactic decoder, ASR 130 generates one or more valid sequences of representations, assign a confidence score to each potential representation, select the potential representation with the highest confidence score, and output said representation, i.e., the recognized text of each segment. ASR 130 also outputs the time index, i.e., the time at the beginning and end of each segment.

Mapper 140 maybe be software modules, hardware modules, or a combination of software and hardware modules, whether separate or integrated, working together to receive the recognized text in sequential order, determine the physical location on the glove which correlates to the recognized text, and transmit the physical locations on the glove in the identical sequential order. In another embodiment, the recognized text is received by mapper 140 along with time information transmitted along with the physical location information.

According to an exemplary embodiment, mapper 140 utilizes a lookup table to correlate the recognized text with physical locations, i.e., stimulation points, on the glove. A lookup table is well known to one skilled in the art of computer programming.

Actuator 150 may be software modules, hardware modules, or a combination of software and hardware modules, whether separate or integrated, working together to operate stimulator 160, which applies a physical stimulus to one or more locations on the gloves. Stimulator 160 may be an actuator which causes a percussive or electrical force at the time and physical location specified by Mapper 140. In another embodiment, stimulator 160 may be lights on the glove that may be individually turned on and off by actuator 150.

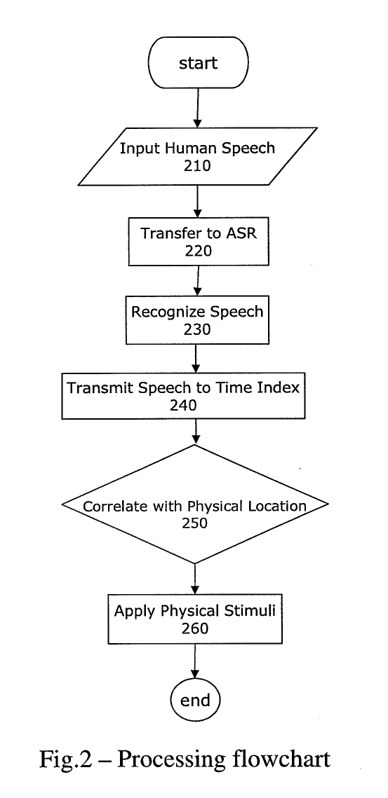

FIG. 2 illustrates a flow chart of a method for hearing with one's hands, according to an embodiment. At step 210, input 120 receives the input human speech. At step 220, input 120 transfers said human speech to ASR 130, which at step 230 receives the human speech, segments the speech, and creates a textual representation of the speech including the time index representing the start and stop of each speech segment.

At step 240, ASR transmits said text and time index information to mapper 140 which, at step 250, for each character, determines a location or locations on the glove to which a physical stimulus will be applied by stimulator 160, at step 260, to represent said character.

While the present application has been particularly shown and described with reference to embodiments thereof, it will be understood by those of ordinary skill in the art that various changes in form and details may be made therein without departing from the spirit and scope according to the present application as defined by the following claims.

1. A system configured to represent human speech as physical stimulus to the user, the system comprising:
a first module configured to obtain human speech;
a second module configured as an automatic speech recognizer (ASR) configured to create a segment of the human speech and create a textual representation of each segment of the human speech;
a third module configured to correspond the textual representations to physical locations on a hand of the user; and
a fourth module configured to stimulate the physical locations on the hand of the user corresponding to the textual representations.

2. The system of claim 1, wherein the second module is further configured to provide time index information for each speech segment.

3. The system of claim 1, wherein the fourth module comprises at least one stimulator configured to apply a percussive force to physical locations on the hand of the user.

4. The system of claim 1, wherein the fourth module comprises at least one stimulator configured to apply an electrical charge to physical locations on the hand of the user.

5. The system of claim 1, wherein the fourth module comprises a series of electrical lights at the physical locations configured to be actuated according to the textual representations.
